(19) United States
(12) Patent Application Publication
(10) Pub. No.: US 2009/0184658 A1
(43) Pub. Date: Jul. 23, 2009

(54) IMAGE DISPLAY APPARATUS

(75) Inventors: Yukihiro Inoue, Ebina-shi (JP); Mineto Yagyu, Hachioji-shi (JP); Masanori Takahashi, Chigasaki-shi (JP); Takashi Date, Machida-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/352,825

(22) Filed: Jan. 13, 2009

(30) Foreign Application Priority Data
Jan. 21, 2008 (JP) 2008-010519

(51) Int. Cl. H05B 41/36

(52) U.S. Cl. 315/291

(57) ABSTRACT

An image display apparatus includes: a rear plate having multiple electron-emitting devices; and a face plate having multiple anode electrodes and a common electrode electrically connected to the multiple anode electrodes, and facing the rear plate. The rear plate has a first conductive member at a position facing the common electrode, and the first conductive member is electrically connected via a resistive device to a second conductive member that is applied with a potential lower than a potential which is applied to the multiple anode electrodes.

### BACKGROUND OF THE INVENTION

1. Field of the Invention

The present invention relates to an image display apparatus having a display panel.

2. Description of the Related Art

Up to now, there have been known two types of electron-emitting devices including a hot cathode device and a cold cathode device. In those devices, as the cold cathode device, there have been known, for example, a surface conduction electron-emitting device, a field emission (FE) device, a metal-insulator-metal (MIM) electron-emitting device, etc. FIG. 7 is a schematic configuration diagram illustrating a multi-electron source in which a large number of cold cathode devices are two-dimensionally arranged, and those devices are wired in matrix.

FIG. 7 illustrates cold cathode devices 4001 schematically, and row wirings 4002 and column wirings 4003. The row wirings 4002 and the column wirings 4003 actually have finite electric resistances, which are indicated by wiring resistances 4004 and 4005 in FIG. 7. The above-mentioned wiring method is called “simple matrix wiring”. For convenience of illustration, 6×6 matrix is illustrated in FIG. 7, but the scale of the matrix is not limited to that example. For example, in the case of a multi-electron source for an image display apparatus, devices of the number required for conducting a desired image display are arrayed and wired.

In the multi-electron source where the cold cathode devices are wired in simple matrix, in order to emit a desired electron beam, appropriate electric signals are applied to the row wirings 4002 and the column wirings 4003, respectively. For example, in order to drive cold cathode devices 4001 on one arbitrary row in matrix, a selected voltage Vs is applied to the row wiring 4002 on the selected row, and at the same time, an unselected voltage Vns is applied to the row wirings 4002 on unselected rows. In synchronization with the application of those voltages, a drive voltage Ve for outputting an electron beam is applied to the row wiring 4003. According to that method, when a voltage drop due to the wiring resistances 4004 and 4005 is ignored, a voltage of (Ve-Vs) is applied to the cold cathode devices on the selected rows, and a voltage of (Ve-Vns) is applied to the cold cathode devices on the unselected rows. When Ve, Vs, and Vns are set to voltages having appropriate levels, the electron beam with a desired intensity is output from only the cold cathode electrodes on the selected row. When the different drive voltage Ve is applied to each of the column wirings 4003, the electron beam with a different intensity is output from each of the devices on the selected rows. When a length of time during which the drive voltage Ve is applied is changed, a length of time during which the electron beam is output can be also changed.

Accordingly, the multi-electron source in which the cold cathode devices are wired in simple matrix has a diverse application potentiality. For example, when an electric signal according to image information is appropriately supplied to the multi-electron source, the multi-electron source can be preferably employed as an electron source for the image display apparatus.

FIG. 8 is a schematic perspective view illustrating an example of a display panel for a flat-screen image display apparatus using the multi-electron source, in which a part of the display panel is cut out for illustrating an internal structure thereof. A rear plate 5005, a side wall 5006, and a face plate 5007 constitute an outer enclosure (airtight container) for maintaining vacuum inside the display panel.

The rear plate 5005 is fixed with a substrate 5001, and N×M cold cathode devices 5002 are formed on the substrate 5001. In this example, N and M are 2 or more positive integers, and appropriately set according to the target number of display pixels. As illustrated in FIG. 8, the N×M cold cathode devices 5002 are wired by M row wirings 5003 and N column wirings 5004. A portion configured by the substrate 5001, the cold cathode devices 5002, the row wirings 5003, and the column wirings 5004 is called “multi-electron source”. An insulating layer (not shown) is formed at each of at least cross portions between the row wirings 5003 and the column wirings 5004 so as to keep electric insulation therebetween.

A fluorescent film 5008 made of phosphor is formed on a lower surface of the face plate 5007, in which the phosphors of three primary colors including red (R), green (G), and blue (B) are separately coated. A black conductor (black matrix) is disposed between the phosphors of the respective colors which form the fluorescent film 5008. Also, a metal back 5009 made of aluminum (Al) or the like is formed on a surface of the fluorescent film 5008 at the rear plate 5005 side.

Terminals Dₓ₁ to D_{xM}, D_{y1} to D_{yN}, and a terminal Hᵥ are connection terminals with an airtight structure for electrically connecting the display panel and a driver circuit (not shown). The respective terminals Dₓ₁ to DXM are electrically connected to the corresponding row wirings 5003 of the multi-electron source, the respective terminals D_{y1} to D_{yN} are electrically connected to the corresponding column wirings 5004 of the multi-electron source, and a terminal Hᵥ is electrically connected to the metal back 5009.

Vacuum of about 10⁻⁶ [torr] is maintained inside the airtight container, and there is more required measures for preventing the deformation or destruction of the rear plate 5005 and the face plate 5007 due to a difference in air pressure between the inside and the outside of the airtight container as a displaying area of the image display apparatus is larger. When the rear plate 5005 and the face plate 5007 are thickened in order to prevent the destruction, not only the weight of the image display apparatus increases, but also a distortion or a parallax of an image when being viewed from an oblique direction occurs. Accordingly, in FIG. 8, there are disposed structure supports (called “spacers” or “ribs”) 5010 each formed of a relatively thin glass plate for supporting the atmospheric pressure. With the above-mentioned configuration, a distance of sub-millimeters or several millimeters is normally kept between the substrate 5001 formed with the multi-electron source and the face plate 5007 formed with the fluorescent film 5008, and high vacuum is maintained inside the airtight container as described above.

In the image display apparatus using the display panel as described above, when a voltage is applied to the respective cold cathode devices 5002 through the terminals Dₓ₁ to D_{xM} and D_{y1} to D_{yN} provided outside the container, electrons are emitted from the respective cold cathode devices 5002. At the same time, a high voltage of several hundreds [V] to several [KV] is applied to the metal back 5009 through the terminal Hv provided outside the container, whereby the emitted electrons are accelerated and collide with the face plate 5007. As a result, the phosphors of the respective colors of the fluorescent film 5008 are excited to emit light, and a color image is displayed.

Incidentally, the structure supports (spacers) 5010 has a face plate 5007 side (upper surface side) joined to the metal back 5009 to which the high voltage is applied, and a rear plate 5005 side (lower surface side) located on the row wirings 5003. For that reason, when the display panel is driven, the high voltage is applied to the upper surface of the spacer 5010 whereas a scanning voltage is applied to the lower surface of the spacer 5010.

A high resistance film made of a conductive material (for example, NiO) is deposited on the entire surface of each of the spacers 5010 in thickness of several hundreds nm (several thousands angstroms). The conductive film is formed for the purpose of uniformizing an electric field inside the display panel when being applied with a high voltage, and the film resistance thereof is set to, for example, a resistance value of about 1×10⁸ to 1×10⁹. For that reason, a current (called “spacer current”) from the high voltage source is allowed to flow in the row wirings from the metal back 5009 through the spacers 5010.

FIG. 9 is a cross-sectional view illustrating a display panel for an image display apparatus using the multi-electron source, which has been fabricated by the inventors of the present invention.

In this example, for simplification of illustration, the row wirings and the column wirings provided on the rear plate 5005 are omitted, and only one of the cold cathode devices 5002 (a surface conduction device is illustrated in this example) which are arranged in matrix is illustrated. The metal back 5009 on which anode electrodes, the phosphors, and the like are arrayed is located at a position facing the rear plate 5005. A vacuum vessel is formed by the rear plate 5005, the face plate 5007, and a peripheral frame (not shown), and the cold cathode devices 5002 are arranged within the vessel that is high in degree of vacuum. The cold cathode device 5002 is driven by a signal source 6001. A voltage is applied between the rear plate 5005 and the metal back 5009 by a high voltage source 6002. Electrons emitted from the cold cathode device 5002 are accelerated toward the metal back 5009 upward in FIG. 9 by a voltage applied from the high voltage source 6002, and collide with the phosphors that face the cold cathode device 5002.

In the image display apparatus, unexpected electric discharge may occur. A high voltage is applied to the metal back 5009, and thus the cold cathode device 5002, the wirings, and the like provided on the rear plate 5005 facing the metal back 5009 are exposed to the high voltage. Accordingly, when a triple point or a foreign matter on which the electric field is concentrated exists on the rear plate 5005, those portions become the electric field concentrated points immediately, and electric discharge is generated in vacuum within the image display apparatus. The generation of electric discharge causes electric charges from the metal back 5009 to flow in the cold cathode device 5002, the wirings, and the like. This induces the cold cathode device 5002 to be destroyed, or the driver circuit connected to the wirings to be destroyed, resulting in the risk that the image quality is seriously deteriorated. When the electric charges of the anode electrode provided on the face plate 5007 are caused to flow into the rear plate 5005 due to electric discharge, a discharge current are caused to flow toward the anode electrode from the high voltage source. Moreover, because a potential of the anode electrode provided on the face plate 5007 becomes close to a potential of the rear plate 5005, there arises such a problem that the anode potential is decreased at the moment of electric discharge.

In order to limit the discharge current, Japanese Patent Application Laid-open No. H10-326583 discloses a technique in which the anode electrode provided on the face plate 5007 is divided into strips inside of an image displaying area, and the respective divided anode electrode segments are connected to a common electrode with a low resistance having the anode potential. According to that technique, an electrostatic capacitance of each of the divided anode electrode segments is suppressed, and the discharge current that flows into the rear plate 5005 from the anode electrode within the image displaying area can be remarkably suppressed. As a result, the destruction of the cold cathode device 5002 or the driver circuit is effectively suppressed. Herein, “image displaying area” means an area between the electron-emitting device and the phosphor that faces the electron-emitting device.

However, electric discharge can occur not only inside the image displaying area in which the anode electrode is divided, but also outside the image displaying area. The anode potential is applied to the common electrode with the low resistance disposed on the face plate 5007. For that reason, when electric discharge occurs immediately below the common electrode disposed outside the image displaying area, a much more discharge current flows as compared with a case in which electric discharge occurs inside the image displaying area. This is because the electrostatic capacitance developed by the common electrode and the rear plate 5005 is large. As a result, the potential of the wirings formed on the rear plate 5005 may be lifted up, the cold cathode device 5002 connected to the wirings may be destructed due to an excessive voltage, and successive pixel defects may occur. Further, in the worst case, a large current flow may even induce destruction of the driver circuit.

### SUMMARY OF THE INVENTION

Under the above-mentioned circumstances, it is an object of the present invention to provide an image display apparatus which is capable of suppressing the destruction of the electron-emitting devices and the driver circuit which is attributable to a large current flowing in the wirings, even if electric discharge occurs outside the image displaying area.

An image display apparatus according to the present invention comprises: a rear plate having multiple electron-emitting devices; and a face plate having multiple anode electrodes and a common electrode electrically connected to the multiple anode electrodes, and facing the rear plate. The rear plate has a first conductive member at a position facing the common electrode, and the first conductive member is electrically connected via a resistive member to a second conductive member that is applied with a potential lower than a potential which is applied to the multiple anode electrodes.

According to the present invention, it is possible to provide an image display apparatus which is capable of suppressing the destruction of the electron-emitting devices and the driver circuit which is attributable to a large current flowing in the wirings, even if electric discharge occurs outside the image displaying area.

Further features of the present invention will become apparent from the following description of exemplary embodiments with reference to the attached drawings.

### BRIEF DESCRIPTION OF THE DRAWINGS

FIG. 1 is a schematic perspective view illustrating a periphery of an image displaying area and a vicinity of an outside of the image displaying area in an image display apparatus according to a first embodiment of the present invention.

FIG. 2 is a cross-sectional view taken along a line 2-2 of FIG. 1.

FIG. 3 is a partially plan view illustrating a rear plate of the image display apparatus illustrated in FIG. 1.

FIG. 4 is a partially plan view illustrating a face plate of the image display apparatus illustrated in FIG. 1.

FIG. 5 is a schematic perspective view illustrating a periphery of an image displaying area and a vicinity of an outside of the image displaying area in an image display apparatus according to a second embodiment of the present invention.

FIG. 6 a cross-sectional view taken along a line 6-6 of FIG. 5.

FIG. 7 is a schematic view illustrating a method of electrically wiring a multi-electron source.

FIG. 8 is a perspective view illustrating an example of a display panel of a conventional flat-screen image display apparatus using the multi-electron source.

FIG. 9 is a main cross-sectional view illustrating the display panel of the conventional image display apparatus using the multi-electron source.

### DESCRIPTION OF THE EMBODIMENTS

Hereinafter, with reference to the accompanying drawings, exemplary embodiments of the present invention are described in detail. In the respective drawings of the embodiments described below, identical or corresponding parts are denoted by the same references.

### First Embodiment

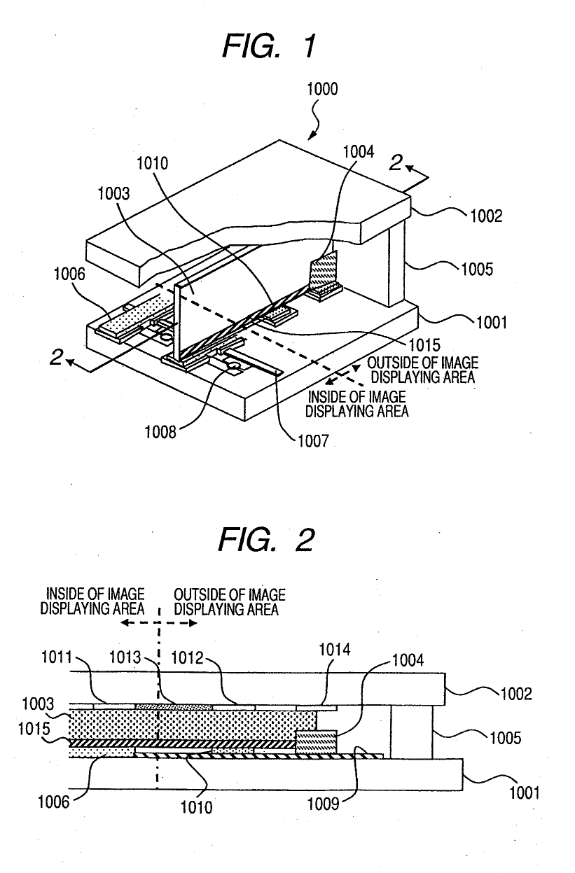

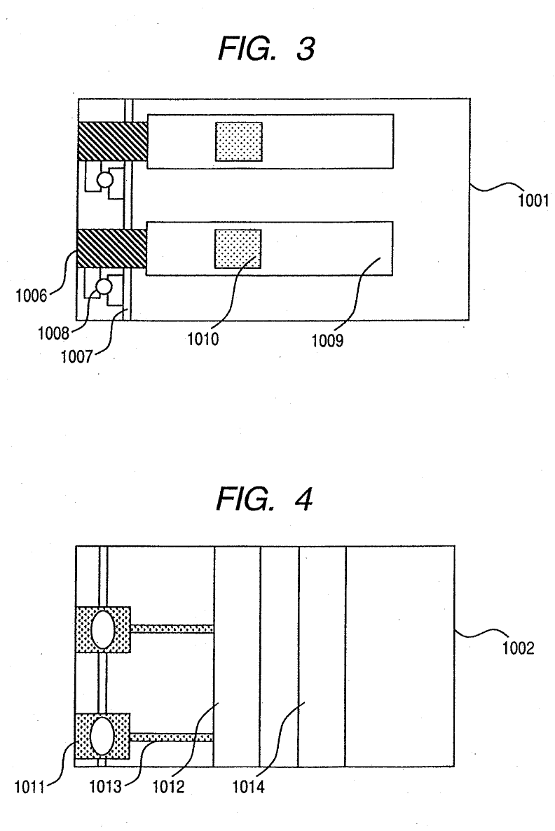

First, an image display apparatus according to a first embodiment of the present invention is described. FIG. 1 is a schematic perspective view illustrating a periphery of an image displaying area and a vicinity of an outside of the image displaying area in the image display apparatus according to the first embodiment of the present invention. FIG. 2 is a cross-sectional view taken along a line 2-2 of FIG. 1. FIG. 3 is a plan view illustrating a rear plate of the image display apparatus. FIG. 4 is a plan view illustrating a face plate of the image display apparatus.

An image display apparatus 1000 according to the present embodiment includes a rear plate 1001, a face plate 1002, and a spacer 1003 that supports the rear plate 1001 and the face plate 1002 against atmospheric pressure. The spacer 1003 is fixed onto the rear plate 1001 by means of a support member 1004. A peripheral frame 1005 for sealing the rear plate 1001 and the face plate 1002 under vacuum, and fixing the rear plate 1001 and the face plate 1002 to each other is disposed between the rear plate 1001 and the face plate 1002.

Row wirings 1006, column wirings 1007, and electron-emitting devices 1008 connected in matrix by those wirings 1006 and 1007 are formed within the image displaying area on the rear plate 1001. The row wirings 1006 correspond to scanning wirings, and the column wirings 1007 correspond to modulation wirings, respectively. The row wirings 1006 extend to the outside of the image displaying area from the inside of the image displaying area, and are led to the external through the peripheral frame 1005 for power feeding. Although not shown, the row wirings 1006 are formed between the rear plate 1001 and an insulating layer 1009 outside the image displaying area. That is, the row wirings 1006 are covered with the insulating layer 1009. As a result, electric discharge frequency to the row wirings 1006 outside the image displaying area can be remarkably reduced.

Phosphors 1011 are formed within the image displaying area on the face plate 1002 so as to face a surface of the rear plate 1001 on which the wirings 1006 and 1007 are disposed. A metal back (not shown) is formed on the phosphor 1011. The metal back is two-dimensionally divided into multiple pieces within the image displaying area. Multiple anode electrodes 1013 with a high resistance are electrically connected to a common electrode 1012. Accordingly, the respective divided metal backs and the phosphors 1011 on the respective metal backs are connected to the common electrode 1012 having an anode potential with a low resistance through the multiple anode electrodes 1013. The common electrode 1012 is formed outside the image displaying area on the face plate 1002. An electrode 1014 defined by a GND potential is formed around the common electrode 1012.

As described above, the image display apparatus according to the present embodiment is of a vacuum vessel structure in which the rear plate 1001 and the face plate 1002 face each other at a given distance, the peripheral frame 1005 is held between both of those plates along an outer periphery thereof, and an inside thereof is sealed in vacuum. Then, the multiple spacers 1003 that support the atmospheric pressure are disposed in parallel to each other on the row wirings 1006 within the vacuum vessel. An end surface of each of the spacers 1003 on the rear plate 1001 side is formed with a resistive device 1015 with a high resistance.

When a high voltage (for example, 10 kV) is applied to the face plate 1002, the phosphor 1011 is irradiated with electrons from the electron-emitting device 1008, whereby a video or an image can be displayed as the image display apparatus.

Incidentally, when an upper end surface of each of the spacers 1003 is insufficiently abutted against the face plate 1002, a large electric field intensity is applied to the abutted portion, resulting in a fear that electric discharge is induced. The spacers 1003 are abutted against the common electrode 1012 outside the image displaying area of the face plate 1002 side, and hence, in order to prevent electric discharge, it is necessary that the common electrode 1012 on the face plate 1002 be electrically abutted against the end surfaces of the spacers 1003. On the other hand, the spacers 1003 are located on the row wirings 1006 as described above, and the row wirings 1006 are coated with the insulating layer 1009 outside the image displaying area of the rear plate 1001 side. For that reason, the spacers 1003 are located on the row wirings 1006 through the insulating layer 1009 outside the image displaying area. However, the insulating layer 1009 is generally made of a hard material, and thus, when the spacers 1003 are fixed onto the insulating layer 1009, there arises a fear that the common electrode 1012 on the face plate 1002 is insufficiently abutted against the spacers 1003. Under the above-mentioned circumstances, in the present invention, in order to obtain a sufficient abutment, a first conductive member 1010 with high deformability is disposed on the insulating layer 1009. With the above-mentioned configuration, the spacers 1003 are pushed against the common electrode 1012 with deformation of the first conductive member 1010, whereby an excellent abutment of the spacers 1003 against the common electrode 1012 can be realized.

It is necessary that the first conductive member 1010 be made of a conductive material such as metal for potential regulation of the spacers 1003. However, in order to obtain a sufficient abutment, it is desirable that the conductive material thereof be easily deformed and be less likely to generate crack when being abutted against the spacers as described above. Further, it is also desirable that the conductive material thereof not affect a surrounding electron source or phosphors. As an example of metal that satisfies those conditions, there are mentioned silver (Ag), copper (Cu), nickel (Ni), and Ni oxide (NiO).

As described above, the first conductive member 1010 is disposed on the rear plate 1001 outside the image displaying area, whereby the electric discharge frequency between the spacers 1003 and the common electrode 1012 is remarkably reduced. However, the first conductive member 1010 is situated at a position facing the common electrode 1012 with a low resistance, and thus there arises a fear that electric discharge is generated between the common electrode 1012 and the first conductive member 1010. For that reason, the first conductive member 1010 is connected to the row wiring 1006 (second conductive member) defined by a potential lower than the anode potential such as a drive potential through the resistive device 1015 (resistive member) with a high resistance which is formed on the end surface of the spacer 1003. The first conductive member 1010 may be connected to the column wiring 1007 as the second conductive member.

With the above-mentioned configuration, electrons supplied from the first conductive member 1010 is restricted by the resistive device 1015 with a high resistance in an initial stage of electric discharge, whereby the electric discharge per se is less likely to occur, and the electric discharge frequency is remarkably decreased. In order to prevent the electric discharge from the common electrode 1012, there is proposed a structure in which a resistive device with a high resistance is disposed between a high-voltage power supply that applies the anode potential and the common electrode 1012 on the face plate 1002 side, whereby a current flowing from the high-voltage power supply is suppressed if electric discharge occurs. However, there may be a case in which a high-voltage input electrode (not shown) for high-voltage power supply is located on the face plate 1002, and a space in which a resistive device with a high resistance is disposed cannot be sufficiently ensured between the high-voltage input electrode and the common electrode 1012. The present embodiment can be implemented even with the above-mentioned restriction.

If electric discharge occurs, electric charges flow into the first conductive member 1010 on the rear plate 1001 facing the common electrode 1012 from the common electrode 1012 with a low resistance which applies the anode potential on the face plate 1002. Then, the electric charges flow into the row wiring 1006 defined by the drive potential through the resistive device 1015 with a high resistance which is formed on the end surface of the spacer 1003. That is, even if electric discharge occurs between the common electrode 1012 with a low resistance on the face plate 1002 and the first conductive member 1010 on the rear plate 1001 facing the common electrode 1012, a discharge current flows through the resistive device 1015 with a high resistance. As a result, the discharge current is restricted. On the rear plate 1001, the first conductive member 1010 is electrically isolated from the row wiring 1006, and therefore electric charges from the face plate 1002 do not flow directly into the row wiring 1006, but flow only through the resistive device 1015 with a high resistance.

Different from a case in which the first conductive member 1010 is connected to a GND potential of another system independent from a wiring potential, the present embodiment has such an advantage that a continuance of electric discharge can be suppressed even if electric discharge occurs once.

When the first conductive member 1010 is connected to the GND potential of another system independent from the wiring potential, electrons are excessively supplied from an independent member in an initial stage of electric discharge, and therefore electric discharge frequency increases. When electric discharge occurs once, electric discharge is maintained through a route of the conductive member with a low resistance. However, in the present embodiment, the first conductive member 1010 is configured to be connected to the row wiring 1006 through the resistive device 1015 with a high resistance. For that reason, electric discharge such that the common electrode 1012 with a low resistance on the face plate 1002 and the row wiring 1006 that is situated at a position not spatially facing the common electrode 1012 are coupled directly with each other is less likely to occur.

As described above, the high resistance film is formed on the entire surface of the spacer 1003, but it is desirable that the resistive device 1015 disposed on the end surface of the spacer 1003 on the rear plate 1001 side be formed of a resistance film lower in resistance than the high resistance film. As a result, a path through which the discharge current flows into the row wiring 1006 through a lower end surface of the spacer 1003 from the first conductive member 1010 is effectively formed. When there is no resistive device 1015, the discharge current flows in the entire surface of the spacer 1003, and therefore it is difficult to form a current path into the row wiring 1006.

In the present embodiment, tungsten that is about 500 kΩ in sheet resistance value is used as the resistive device 1015. In this case, a resistance value of about 7.5 kΩ can be realized when the resistive device 1015 is 3 mm in length and 0.2 mm in width, and hence, when the anode potential is set to, for example, 10 kV, a value of a current flowing in the resistive device 1015 is about 1.3 A. Accordingly, a value of a current flowing in the row wiring 1006 is also about 1.3 A, which enables to prevent the destruction of the electron-emitting device 1008 connected to the row wiring 1006 as well as the destruction of the driver circuit. It is needless to say that a length and a width of the resistive device 1015 are not limited to the above-mentioned values. The same advantages can be expected when the resistive device 1015 is appropriately designed according to magnitude of a permissible discharge current, or resistances of the respective wirings, electrodes or the like. In general, it is desirable that the resistance value of the resistive device 1015 be equal to or higher than 1 kΩ.

### Second Embodiment

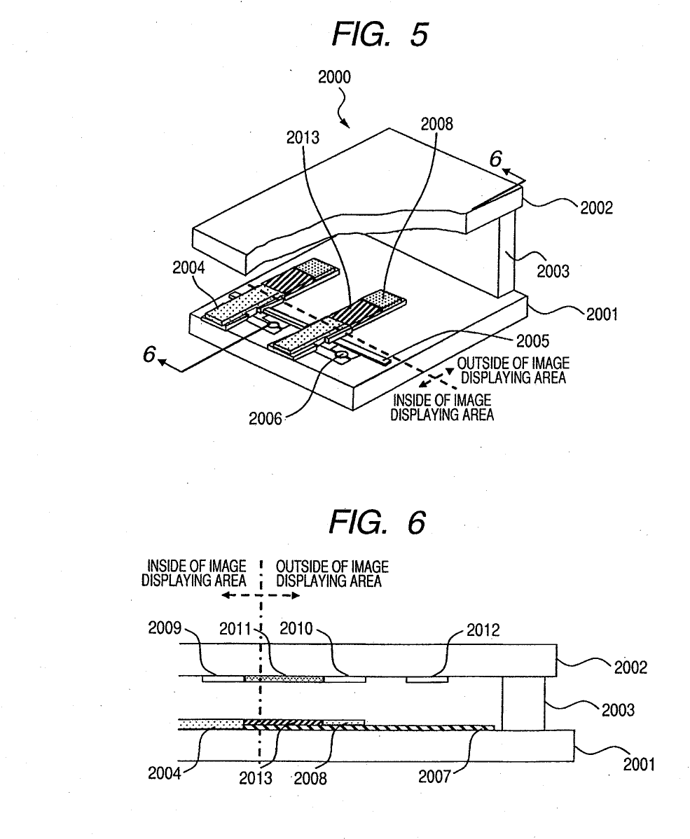

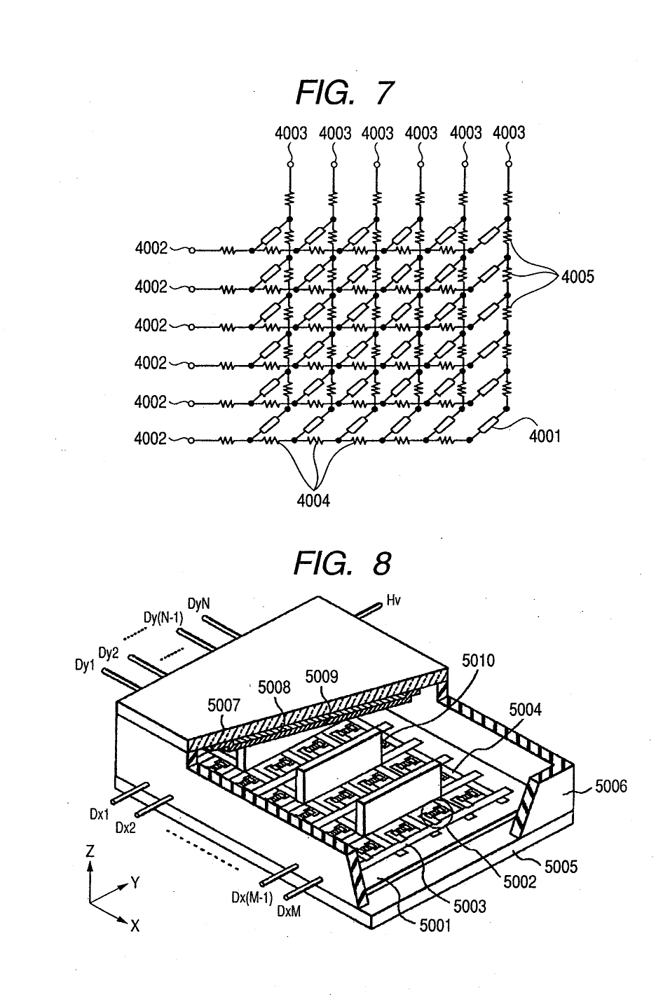

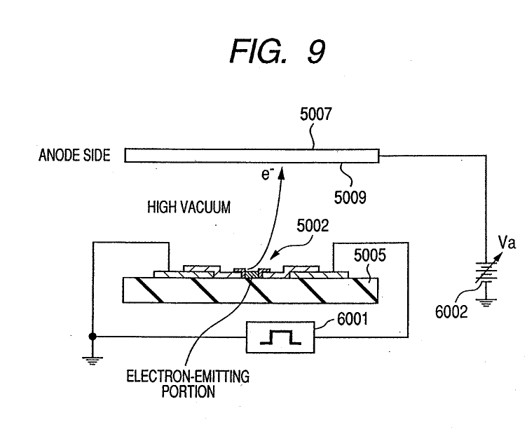

Next, an image display apparatus according to a second embodiment of the present invention is described. FIG. 5 is a schematic perspective view illustrating a periphery of an image displaying area and a vicinity of an outside of the image displaying area in the image display apparatus according to the second embodiment of the present invention. FIG. 6 is a cross-sectional view taken along a line 6-6 of FIG. 5. In the first embodiment, the present invention is applied to the row wirings on which the spacers are arranged. On the other hand, in the present embodiment, the present invention is applied to the row wirings on which the spacers are not arranged.

An image display apparatus 2000 according to the present embodiment includes a rear plate 2001 and a face plate 2002. A peripheral frame 2003 is disposed between the rear plate 2001 and the face plate 2002. The peripheral frame 2003 seals the rear plate 2001 and the face plate 2002 under vacuum, and fixes those plates to each other.

Row wirings 2004, column wirings 2005, and electron-emitting devices 2006 connected in matrix by those wirings 2004 and 2005 are formed within the image displaying area on the rear plate 2001. The row wirings 2004 correspond to scanning wirings, and the column wirings 2005 correspond to modulation wirings, respectively. Phosphors 2009 are formed within the image displaying area on the face plate 2002 so as to face a surface of the rear plate 2001 on which the wirings 2004 and 2005 are disposed. Multiple anode electrodes 2011 are electrically connected to a common electrode 2010. The row wirings 2004 extend to the outside of the image displaying area from the inside of the image displaying area, and are led to the external through the peripheral frame 2003 for power feeding. Although not shown, the row wirings 2004 are formed between the rear plate 2001 and an insulating layer 2007 outside the image displaying area. That is, the row wirings 2004 are covered with the insulating layer 2007. As a result, electric discharge frequency to the row wirings 2004 outside the image displaying area can be remarkably reduced.

In the present embodiment, outside the image displaying area, a first conductive member 2008 is disposed on the rear plate 2001 that faces the common electrode 2010 with a low resistance, and a high resistance film 2013 (resistive device) is formed between the first conductive member 2008 and the row wiring 2004. The first conductive member 2008 is connected to the row wiring 2004 (second conductive member) defined by a drive potential through the high resistance film 2013. Like the first embodiment, the first conductive member 2008 may be connected to the row wiring 2005 as the second conductive member.

With the above-mentioned configuration, electrons supplied from the first conductive member 2008 is restricted by the high resistance film 2013 in an initial stage of electric discharge, whereby the electric discharge per se is less likely to occur, and the electric discharge frequency is remarkably reduced.

If electric discharge occurs, electric charges flow into the first conductive member 2008 on the rear plate 2001 facing the common electrode 2010 from the common electrode 2010 with a low resistance which applies an anode potential on the face plate 2002. Then, the electric charges flow into the row wiring 2004 defined by the drive potential through the high resistance film 2013. That is, even if electric discharge occurs between the common electrode 2010 with a low resistance on the face plate 2002 and the first conductive member 2008 disposed on the rear plate 2001 facing the common electrode 2010, a discharge current flows through the high resistance film 2013. As a result, the discharge current is restricted. On the rear plate 2001, the first conductive member 2008 is electrically isolated from the row wiring 2004, and therefore electric charges from the face plate 2002 do not flow directly into the row wiring 2004, but flow only through the high resistance film 2013.

Further, the common electrode 2010 with a low resistance on the face plate 2002 and the row wirings 2004 connected to the electron-emitting devices 2006 which are arranged on the rear plate 2001 are located at positions not spatially facing each other. For that reason, electric discharge such that the common electrode 2010 is coupled directly with the row wirings 2004 is less likely to occur.

For example, when the high resistance film 2013 that is about 2 GΩ in sheet resistance value is used, a resistance value of about 17 GΩ can be realized when a length thereof is 3 mm and a width thereof is 0.35 mm. Therefore, when it is assumed that the anode potential is, for example, 10 kV, a value of a current flowing in the high resistance film 2013 is about 0.6 μA. Accordingly, a value of a current flowing in the row wiring 2004 is also about 0.6 μA, which enables to prevent the destruction of the electron-emitting devices 2006 connected to the row wirings 2004 and the destruction of the driver circuit. It is needless to say that the length and width of the high resistance film 2013 are not limited to the above-mentioned values. The same advantages can be expected when the high resistance film 2013 is appropriately designed according to magnitude of a permissible discharge current, or resistances of the respective wirings, electrodes, or the like.

It should be noted that the second embodiment and the first embodiment can be combined together.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-010519, filed Jan. 21, 2008, which is hereby incorporated by reference herein in its entirety.

What is claimed is:

1. An image display apparatus, comprising:
a rear plate having multiple electron-emitting devices; and
a face plate having multiple anode electrodes and a common electrode electrically connected to the multiple anode electrodes, and facing the rear plate,
wherein the rear plate has a first conductive member at a position facing the common electrode, and the first conductive member is electrically connected via a resistive member to a second conductive member that is applied with a potential lower than a potential which is applied to the multiple anode electrodes.

2. An image display apparatus according to claim 1, further comprising a spacer disposed between the rear plate and the face plate,
wherein the first conductive member is disposed between the spacer and the rear plate.

3. An image display apparatus according to claim 2, wherein the resistive member is disposed on an end surface on a rear plate side of the spacer.

4. An image display apparatus according to claim 2, further comprising a resistance film formed on an entire surface of the spacer,
wherein the resistive member is smaller in resistance than the resistance film.

5. An image display apparatus according to claim 3, further comprising a resistance film formed on an entire surface of the spacer,
wherein the resistive member is smaller in resistance than the resistance film.

6. An image display apparatus according to claim 1, wherein the first conductive member is made of metal.

7. An image display apparatus according to claim 6, wherein the metal is selected from the group consisting of silver, copper, nickel, and nickel oxide.

8. An image display apparatus according to claim 1, wherein a resistance value of the resistive member is equal to or larger than 1 kΩ.

9. An image display apparatus according to claim 1, wherein
the rear plate has scanning wirings and modulation wirings which connect the multiple electron-emitting devices in matrix, and
the second conductive member comprises one of the scanning wirings and the modulation wirings.

10. An image display apparatus according to claim 2, wherein
the rear plate has scanning wirings and modulation wirings which connect the multiple electron-emitting devices in matrix, and
the second conductive member comprises one of the scanning wirings and the modulation wirings.
